(19) United States
(12) Patent Application Publication
(10) Pub. No.: US 2023/0299713 A1
(43) Pub. Date: Sep. 21, 2023

(54) EXTENSIBLE SOLAR MODULE

(71) Applicant: XIAMEN DONESTY ECOMMERCE CO., LTD., Xiamen (CN)

(72) Inventors: Hao WANG, Xiamen (CN); Haojun HONG, Xiamen (CN)

(21) Appl. No.: 17/824,283

(22) Filed: May 25, 2022

(30) Foreign Application Priority Data
Mar. 15, 2022 (CN) 202220536515.3

(51) Int. Cl. H02S 30/20; H02S 30/10; H02S 40/30

(52) U.S. Cl. CPC H02S 30/20; H02S 30/10; H02S 40/30

(57) ABSTRACT

An extensible solar module comprising a solar panel member which comprises a main board, a first sub board and a second sub board located on both sides of the main board; a driving member which comprises a DC motor and a connecting rod assembly; wherein the connecting rod assembly is connected with the first sub board and the second sub board, such that the first sub board and the second sub board can be extended and retracted relative to the main board more stably under the driving of the DC motor, so as to make full use of the available space, and has the simple structure, light weight and low cost.

### CROSS-REFERENCE TO RELATED APPLICATION

The instant application claims priority to Chinese Patent Application 202220536515.3, filed on Mar. 15, 2022, which is incorporated herein by reference.

### TECHNICAL FIELD

The disclosure relates to a solar module, in particular to an extensible solar module.

### BACKGROUND

With the popularity of RV (recreational vehicle), more and more people choose RV as a way of travel. When the RV is traveling, the daily life is in the RV, so there will be a great demand for electricity, and usually people will choose the way of solar power generation. Because the roof space of RV is limited, how to increase the power generation area has become an urgent technical problem to be solved, and the extensible solar module has been raised. However, extensible solar modules still need to pay attention to the overall cost and weight. In addition, it is also necessary to ensure the available space and stability of extensible solar modules after extension.

### SUMMARY

In view of this, an extensible solar module is provided which includes: a solar panel member including: a main board; a first sub board and a second sub board located on both sides of the main board; a driving member including a DC motor and a connecting rod assembly, wherein the connecting rod assembly is connected with the first sub board and the second sub board, such that the first sub board and the second sub board can be extended and retracted relative to the main board under the driving of the DC motor. When extension, the first sub board and the second sub board are located on the opposite sides of the main board, and when retraction, the first sub board and the second sub board are moved to the back of the main board, and the facing edges of the first sub board and the second sub board are adjacent to each other.

Preferably, the connecting rod assembly includes: a driving main rod; a first side rod; a second side rod, the first side rod and the second side rod are respectively arranged at both ends of the driving main rod; a first connecting bearing, one end of the first side rod is connected with the first sub board, and the other end of the first side rod is connected with the driving main rod through the first connecting bearing; a second connecting bearing, one end of the second side rod is connected with the second sub board, and the other end of the second side rod is connected with the driving main rod through the second connecting bearing.

Preferably, one end of the first side rod connected with the first sub board forms a right angle structure, and one end of the second side rod connected with the second sub board also forms a right angle structure.

Preferably, the lower end of the right angle structure of the first side rod is provided with a first semi-cylindrical tail. When the first side rod is connected with the first sub board through the first connecting bearing, the first semi-cylindrical tail can be inserted into the first connecting bearing. The lower end of the right angle structure of the second side rod is provided with a second semi-cylindrical tail. When the second side rod and the second sub board are connected through the second connecting bearing, the second semi-cylindrical tail can be inserted into the second connecting bearing.

Preferably, the main board is an aluminum frame glass structure and includes an aluminum frame, the first sub board and the second sub board are PCB boards, and the short side of the aluminum frame of the main board is provided with two sub board extension grooves corresponding to the first sub board and the second sub board.

Preferably, two sliding rail supports are provided on the aluminum frame of the main board along its long side, such that a guide rail is mounted in each of the sliding rail supports. The first sub board and the second sub board can be extended or retracted relative to the main board through the guide rails.

Preferably, the DC motor is provided with a motor support for installing the DC motor on the aluminum frame of the main board, the motor support is provided with a via, the DC motor is provided with a flange bearing seat, and the DC motor is connected with the motor support through the flange bearing seat.

According to another embodiment of the disclosure, the DC motor is a double output shaft motor, and the connecting rod assembly includes a first screw rod and a second screw rod, one end of the first screw rod and one end of the second screw rod are respectively connected to the two output shafts of the double output shaft motor, and the other end of the first screw rod and the other end of the second screw rod are respectively connected to the aluminum frame of the main board; a first slider and a second slider, the first slider is threaded on the first screw rod and connected to the first sub board, and the second slider is threaded on the second screw rod and connected to the second sub board.

Preferably, the extensible solar module also includes a limiting member arranged on the motor support and including: an extension limiting member which is triggered when the first sub board and the second sub board are in their fully extended position to turn off the operation of the DC machine; and a retraction limiting member which is triggered when the first sub board and the second sub board are in their full retraction position to turn off the operation of the DC motor.

Preferably, the extension limiting member and the retraction limiting member are both metal sensors.

Preferably, when the motor transmission structure is not provided, the extensible solar module also includes a mechanical locking member which is respectively arranged on the first sub board and the second sub board and includes a latch and a baffle, the latch includes an inclined face and a button part, and the inclined face is locked on the aluminum frame of the main board at the full retraction position of the first sub board and the second sub board relative to the main board, and the locking of the inclined face can be released by pressing the button part.

According to another embodiment of the disclosure, as described in detail in the disclosure, when a motor transmission structure is provided, the extensible solar module includes an electromagnetic lock.

The driving member according to the disclosure is a modular structure.

The extension and the retraction of the extensible solar module structure according to the disclosure are more stable, and can make full use of the available space, and has the simple structure, light weight and low cost.

### BRIEF DESCRIPTION OF THE DRAWINGS

The accompanying drawings are included herein to provide a further understanding of the disclosure, and are incorporated into this specification to constitute a part of this specification. The accompanying drawings illustrate embodiments of the disclosure, and are used together with the following description to illustrate the concept of the disclosure.

In the drawings:

FIG. 1 is a schematic diagram of the external structure of an extensible solar module according to the present disclosure;

FIGS. 2a and 2b are schematic diagrams of the extensible solar module installed on the RV according to the present disclosure, wherein FIG. 2a shows the solar panel member in the retraction state, and FIG. 2b shows the solar panel member in the extension state;

FIG. 3 is a schematic diagram of the internal structure of an extensible solar module according to the present disclosure;

FIG. 4 is a structural diagram of a connecting rod assembly of an extensible solar module according to the present disclosure;

FIG. 5 is another structural diagram of the connecting rod assembly of the extensible solar module according to the present disclosure;

FIG. 6 is a schematic diagram showing the angle of the driving member according to the present disclosure;

FIG. 7 is a schematic diagram showing a specific structure of a main board of an extensible solar module according to the present disclosure;

FIG. 8 is another schematic diagram showing the specific structure of the main board of the extensible solar module according to the present disclosure;

FIG. 9 is a schematic diagram showing the installation structure of a DC motor and a main board according to the present disclosure;

FIG. 10 is a schematic diagram showing the installation structure of the DC motor and the main board, the first sub board and the second sub board according to the disclosure;

FIG. 11 is a schematic diagram showing the structure of a connecting rod assembly according to a second embodiment of the present disclosure;

FIG. 12 is a schematic diagram showing a limiting member according to the present disclosure;

FIG. 13 is a schematic diagram showing the matching relationship between the limiting member and the connecting rod assembly according to the present disclosure;

FIG. 14 is a schematic diagram showing the installation position of the locking member according to the disclosure; and

FIG. 15 is a schematic diagram showing a specific structure of a latch of a locking member according to the present disclosure.

### DETAILED DESCRIPTION

The following specific description is intended to illustrate exemplary embodiments and is not intended to be limited to these explicitly disclosed combinations. Thus, unless otherwise noted, the features disclosed herein may be combined to form additional combinations not given for simplicity.

Although the preferred embodiment of the disclosure has been shown and described, it will be apparent to those skilled in the art that it can be changed and modified without departing from the spirit of the disclosure, and the scope of the disclosure is limited by the appended claims. Similar components are designated by similar reference numerals.

Hereinafter, the application of the extensible solar module to the RV is described as an example. However, the extensible solar module according to the disclosure can also be applied to other facilities, such as various house roofs, hillsides, etc.

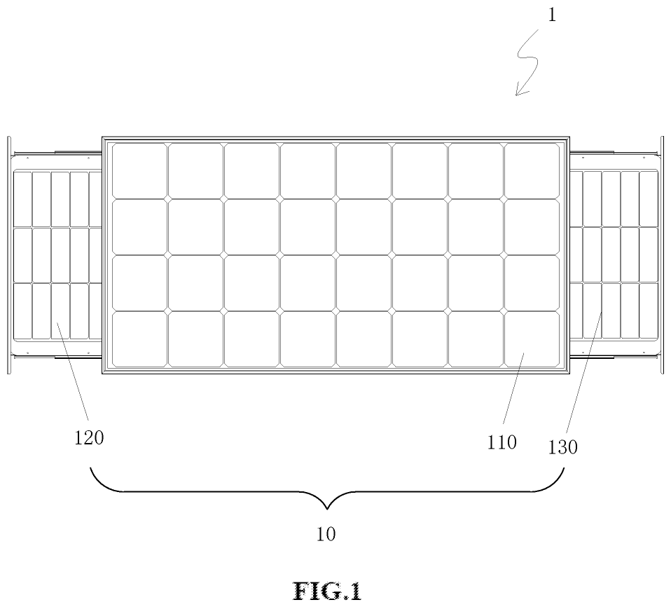

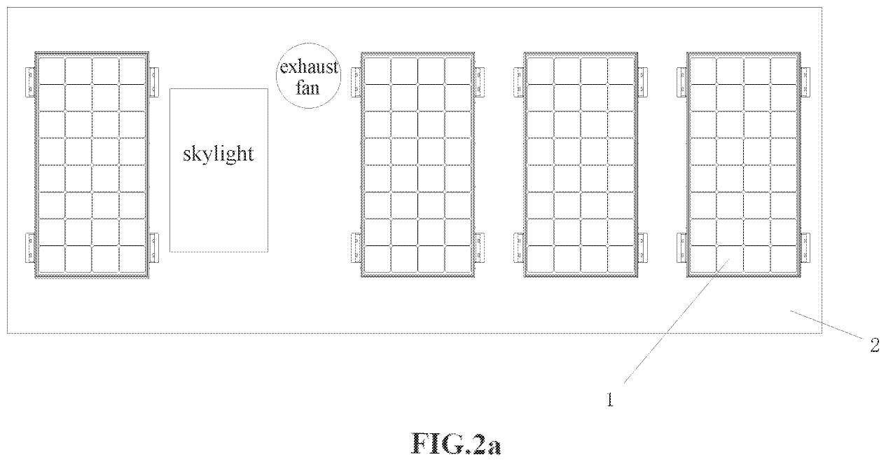

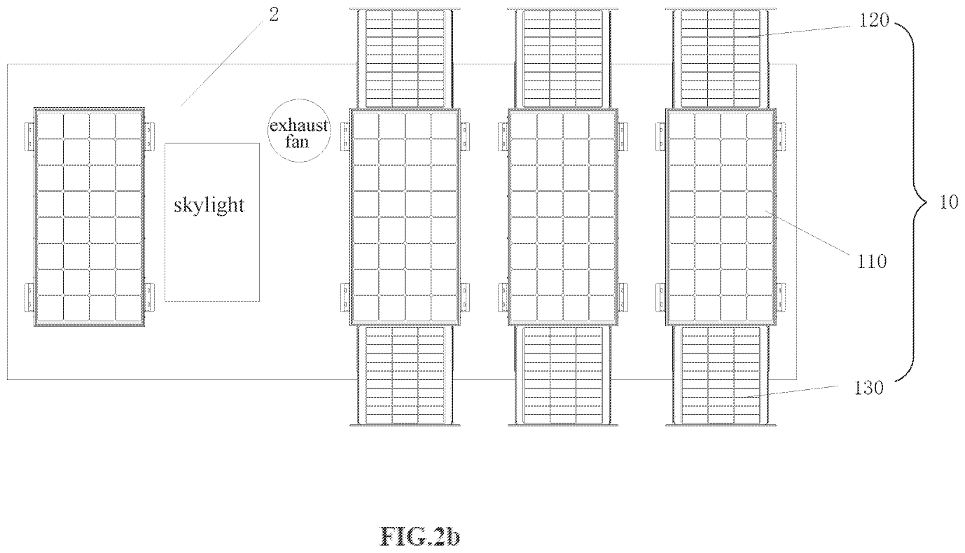

FIG. 1 schematically shows the overall structure of the extensible solar module 1 of the present disclosure. The extensible solar module 1 mainly includes a solar panel member 10. As shown in FIG. 1, the solar panel member 10 also includes a main board 110 and a first sub board 120 and a second sub board 130 located on opposite two sides of the main board 110. The first sub board 120 and the second sub board 130 can be extended and retracted relative to the main board 110. According to an exemplary embodiment of the disclosure, the extensible solar module 1 can be installed on the roof of the RV. As shown in FIGS. 2a and 2b, wherein FIG. 2a shows the extensible solar module in the retracted state and FIG. 2b shows the extensible solar module in the extended state. A plurality of extensible solar modules 1 can be arranged along the longitudinal direction of the roof of the RV 2, and the first sub board 120 and the second sub board 130 can be extended and retracted in a transverse direction perpendicular to the longitudinal direction of the roof of the RV 2. Such arrangement can ensure the maximum use of roof space and provide the maximum extension space of the first sub board 120 and the second sub board 130.

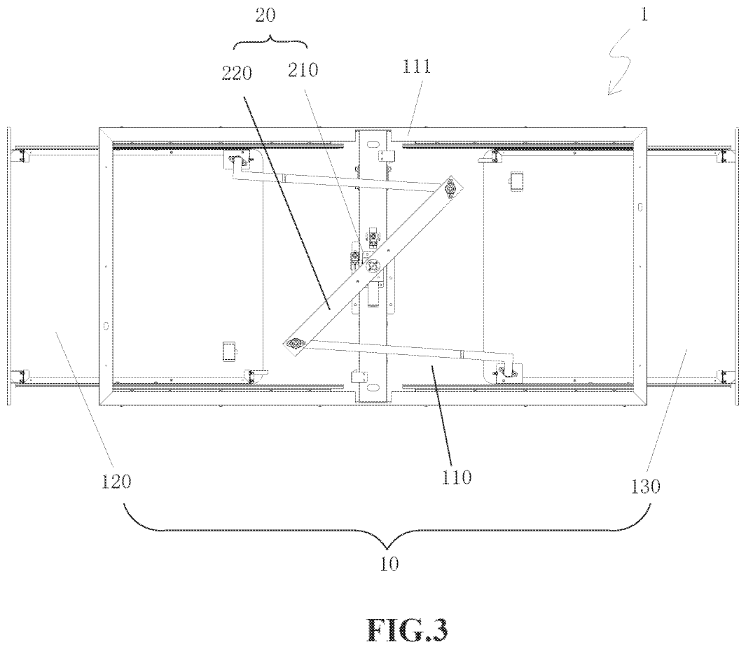

The extensible solar module 1 according to the disclosure also includes a driving member 20, as shown in FIG. 3, which is a structural diagram of the extensible solar module 1 according to the disclosure, wherein the driving member 20 includes a DC motor 210 and a connecting rod assembly 220, the connecting rod assembly is connected with the first sub board 120 and the second sub board 130, such that the first sub board 120 and the second sub board 130 can be extended and retracted relative to the main board 110 under the driving of the DC motor 210. When extension, the first sub board 120 and the second sub board 130 are located on the opposite sides of the main board 110, and when retraction, both the first sub board 120 and the second sub board 130 move to the back of the main board 110, and the opposite edges of the first sub board 120 and the second sub board 130 are adjacent to each other. That is, in the retracted state, the first sub board 120, the second sub board 130 and the main board 110 form a two-layer structure, which can reduce the size of the first sub board 120 and the second sub board 130, and thusly reduce the occupied space and the overall weight and the burden of the sliding rail, and improve the practicability and safety.

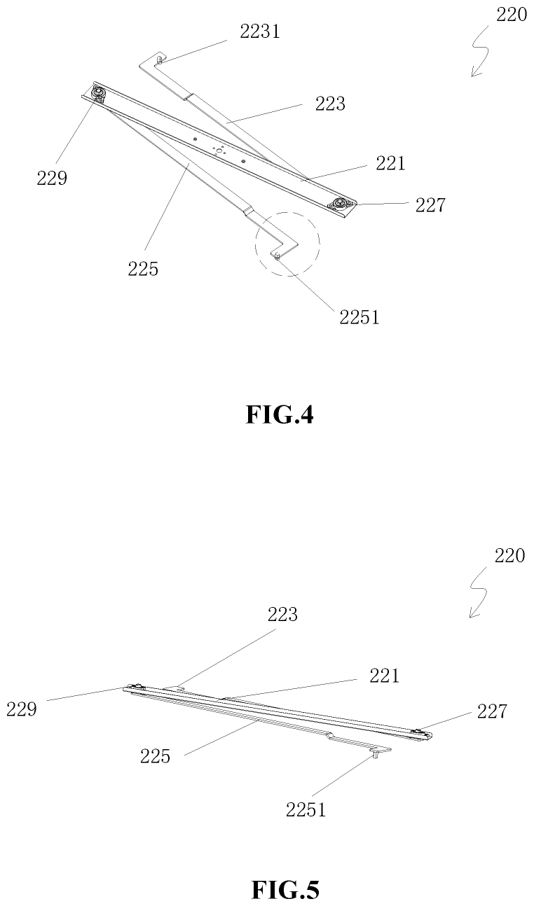

Specifically, with reference to FIGS. 4 and 5, wherein FIG. 4 is a structural diagram of the connecting rod assembly 220 of the extensible solar module 1 according to the present disclosure; FIG. 5 is another structural diagram of the connecting rod assembly 220 of the extensible solar module 1 according to the present disclosure. The connecting rod assembly 220 includes a driving main rod 221, a first side rod 223, a second side rod 225, a first connecting bearing 227 and a second connecting bearing 229. The first side rod 223 and the second side rod 225 are respectively arranged at both ends of the driving main rod 221; specifically, one end of the first side rod 223 is connected with the first sub board 120, and the other end of the first side rod 223 is connected with the driving main rod 221 through the first connecting bearing 227; similarly, one end of the second side rod 225 is connected with the second sub board 130, and the other end of the second side rod 225 is connected with the driving main rod 221 through the second connecting bearing 229. The connection between the first side rod 223 and the driving main rod 221, and the connection between the second side rod 225 and the driving main rod 221 are carried out through the first connecting bearing 227 and the second connecting bearing 229 respectively. The first connecting bearing 227 and the second connecting bearing 229 not only play the role of connection, but also make the movement of the connecting portion smoother, wear less and greatly increase the service life.

In addition, as clearly shown in the circle part in FIG. 4, one end of the first side rod 223 connected with the first sub board 120 forms a right angle structure, that is, the first side rod 223 forms an L-shaped structure; Similarly, one end of the second side rod 225 connected with the second sub board 130 also forms a right angle structure, that is, the second side rod 225 is also formed into an L-shaped structure. And preferably, the lower end of the right angle structure of the first side rod 223 is provided with a first semi-cylindrical tail 2231, and the lower end of the right angle structure of the second side rod 225 is provided with a second semi-cylindrical tail 2251. The connection between the first side rod 223 and the first sub board 120 can also be carried out through the first connecting bearing (not shown), and the first semi-cylindrical tail 2231 can be inserted into the first connecting bearing. Similarly, the connection between the second side rod 225 and the second sub board 130 can also be carried out through the second connecting bearing (not shown), and the second semi-cylindrical tail 2251 can be inserted into the second connecting bearing.

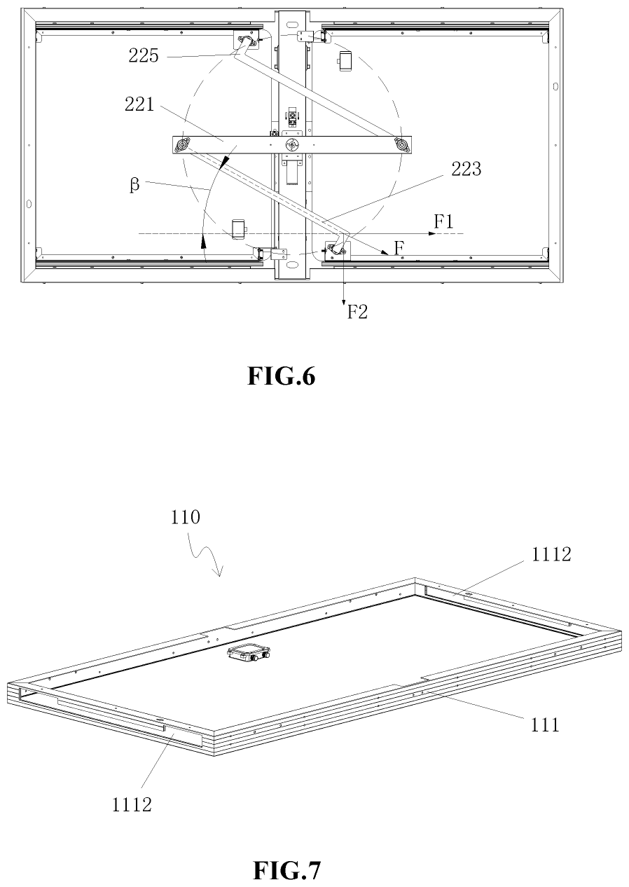

The angle of the driving member according to the present disclosure is described below with reference to FIG. 6. As shown in FIG. 6, taking the first side rod 223 as an example, the force applied by the driving main rod 221 to the first side rod 223 is F, the horizontal component of the force F is F1, the vertical component of the force F is F2, and the angle between the horizontal component F1 and the first side rod 223 is β. During the continuous retraction and extension of the extensible solar module, both the position of the first side rod 223 and the angle β change continuously. Considering the length of the driving main rod 221 and the distance between the guide rails on both sides, the angle β is preferably the minimum.

In the embodiment according to the disclosure, both the first side rod 223 and the second side rod 225 are an L-shaped structure. Therefore, compared with the side rod in a linear shape, L-shaped side rod can reduce angle β, which thusly can increase the horizontal component F1 and minimize the vertical component F2, so as to reduce the pressure on the guide rail.

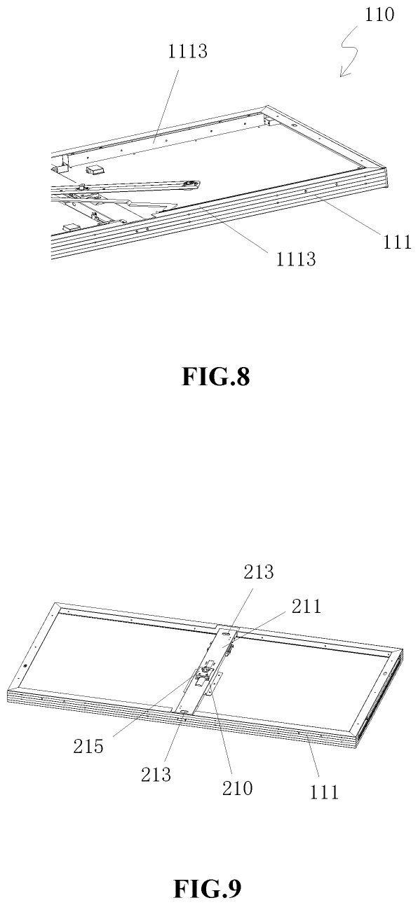

Next, the specific structure of the main board 110 of the extensible solar module is described with reference to FIG. 7 and FIG. 8. FIG. 7 is a schematic diagram showing the specific structure of the main board of the extensible solar module according to the present disclosure, and FIG. 8 is another schematic diagram showing the specific structure of the main board of the extensible solar module according to the present disclosure. As shown in FIG. 7 and FIG. 8, the main board 110 is an aluminum frame glass structure and includes an aluminum frame 111. The aluminum frame 111 is provided with two sub board extension grooves 1112 corresponding to the first sub board 120 and the second sub board 130, respectively. According to the embodiment shown in FIG. 7, the two sub board extension grooves 1112 are arranged along the short side of the aluminum frame 111, and the first sub board 120 and the second sub board 130 extend and retract relative to the main board 110 respectively by passing through the above two sub board extension grooves 1112. According to this embodiment, both the first sub board 120 and the second sub board 130 are PCB boards. The aluminum frame 111 is also provided with two sliding rail supports 1113. As shown in FIG. 8, the sliding rail supports 1113 are arranged on the two opposite long sides of the aluminum frame 111, a guide rail (not shown) can be arranged in each of the two sliding rail supports 1113 respectively, and the first sub board 120 and the second sub board 130 can be extended and retracted relative to the main board 110 along the guide rail. Based on the preferred embodiment, the guide rail is a three section sliding rail.

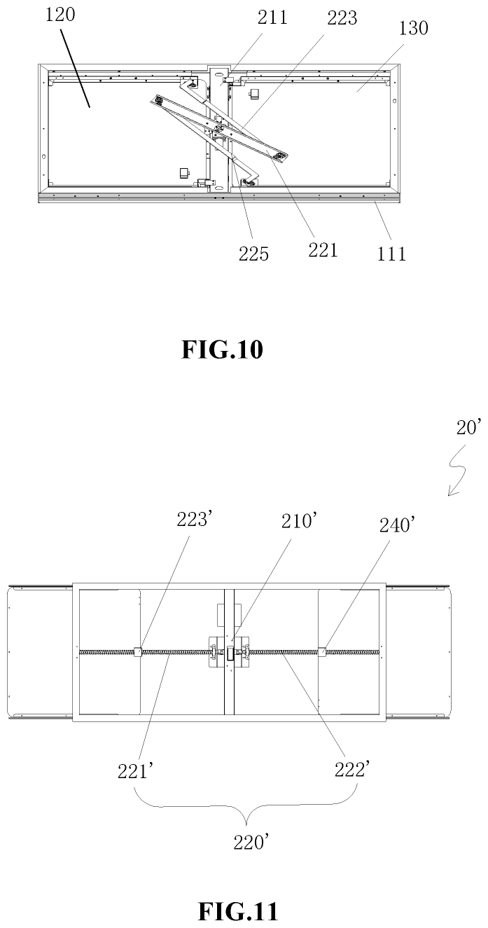

The installation of the DC motor 210 and the main board 110 is described below with reference to FIGS. 9 and 10, wherein FIG. 9 is a schematic diagram showing the installation structure of the DC motor and the main board according to the disclosure, and FIG. 10 is a schematic diagram showing the installation structure of the DC motor, the main board, the first sub board and the second sub board according to the disclosure. The DC motor 210 is provided with the motor support 211, and the DC motor 210 is mounted on the aluminum frame 111 of the main board 110 through the motor support 211, as shown in FIG. 9. The motor support 211 is also provided with a wire via 213 for arranging and routing the wires. In addition, the DC motor 210 is also provided with a flange bearing seat 215, and an output shaft of the DC motor 210 is connected with the connecting rod assembly through the flange bearing seat 215.

Based on the above structure, for example, through the forward rotation of the DC motor 210, the output shaft of the DC motor 210 drives the driving main rod 221 to pivot, and the driving main rod 221 drives the first side rod 223 and the second side rod 225 to pivot together. The first side rod 223 and the second side rod 225 drive the first sub board 120 and the second sub board 130 to move away from each other, such that the first sub board 120 and the second sub board 130 are extended relative to the main board 110. When the DC motor 210 rotates reversely, the output shaft of the DC motor 210 drives the driving main rod 221 to pivot in the opposite direction, and then the driving main rod 221 drives the first side rod 223 and the second side rod 225 to pivot in the opposite direction. Therefore, the first side rod 223 and the second side rod 225 drive the first sub board 120 and the second sub board 130 to move in the direction close to each other, such that the first sub board 120 and the second sub board 130 are retracted relative to the main board 110.

The structure of the connecting rod assembly according to the second embodiment of the present disclosure is described below with reference to FIG. 11, which is a schematic diagram showing the structure of the connecting rod assembly according to the second embodiment of the present disclosure. As shown in FIG. 11, the DC motor according to the embodiment is a double output shaft motor 210′, and the connecting rod assembly 220′ according to the embodiment includes a first screw rod 221′ and a second screw rod 222′. One end of the first screw rod 221′ is connected to an output shaft of the double output shaft motor 210′, and the other end of the first screw rod 221′ is connected to the aluminum frame 111 of the main board 110; Similarly, one end of the second screw rod 222′ is connected to the other output shaft of the double output shaft motor 210′, and the other end of the second screw rod 222′ is also connected to the aluminum frame 111 of the main board 110. The first screw rod 221′ is provided with a first slider 223′, the second screw rod 222′ is provided with a second slider 224′, the first slider 223′ is threaded on the first screw rod 221′ and connected to the first sub board 120, and the second slider 224′ is threaded on the second screw rod 222′ and connected to the second sub board 130.

Based on this embodiment, when the double output shaft motor 210′ rotates forward, the two output shafts of the double output shaft motor 210′ drive the first screw rod 221′ and the second screw rod 222′ to rotate, and the first slider 223′ and the second slider 224′ is driven by the first screw rod 221′ and the second screw rod 222′ respectively, so as to push the first sub board 120 and the second sub board 130 outward in a direction away from each other. When the double output shaft motor 210′ rotates reversely, the two output shafts of the double output shaft motor 210′ drive the first screw rod 221′ and the second screw rod 222′ to rotate in the opposite direction. At the same time, the first slider 223′ and the second slider 224′ is driven by the first screw rod 221′ and the second screw rod 222′ respectively, so as to push the first sub board 120 and the second sub board 130 inward in the direction close to each other.

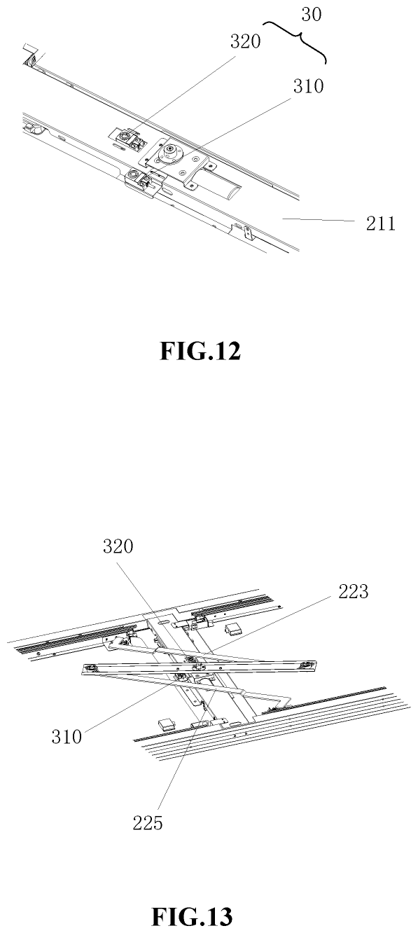

In order to avoid damage to the motor itself or other components caused by the inability of the DC motor 210 to stop at an extreme position, the extensible solar module 1 according to the present disclosure also includes a limiting member 30. The limiting member 30 according to the present disclosure will be described below with reference to FIGS. 12 and 13, wherein FIG. 12 is a schematic diagram showing the limiting member according to the present disclosure, FIG. 13 is a schematic diagram showing the matching relationship between the limiting member and the connecting rod assembly according to the present disclosure. As shown in FIG. 12, the limiting member 30 according to the disclosure can be arranged on the motor support 211 and includes an extension limiting member 310. When the first sub board 120 and the second sub board 130 are in their fully extended position, the extension limiting member 310 is triggered to turn off the operation of the DC motor 210. The limiting member 30 also includes a retraction limiting member 320. When the first sub board 120 and the second sub board 130 are in their fully retracted position, the retraction limiting member 320 is triggered to turn off the operation of the DC motor 210. According to this embodiment, both the extension limiting member 310 and the retraction limiting member 320 are metal sensors.

As shown in FIG. 13, when the first sub board 120 and the second sub board 130 are in the extended state, the first side rod 223 and the second side rod 225 are located above the extension limiting member 310, so as to trigger the induction. The controller judges that the first sub board 120 and the second sub board 130 have been fully extended according to this signal, and then turns off the operation of the DC motor 210. When the first sub board 120 and the second sub board 130 are in the retracted state, the first side rod 223 and the second side rod 225 are located above the retraction limiting member 320, so as to trigger the induction. The controller judges that the first sub board 120 and the second sub board 130 are in the fully retraction state, and then turns off the operation of the DC motor 210.

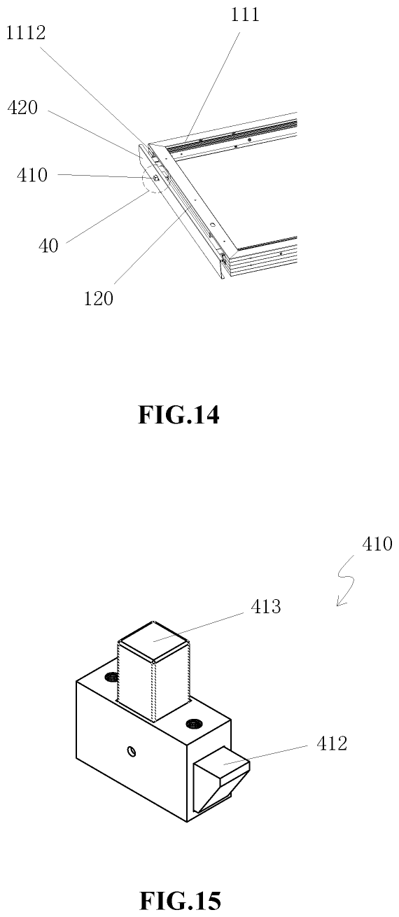

The extensible solar module according to the disclosure is usually installed on the roof of an RV. In order to prevent the first sub board 120 and the second sub board 130 from being undesirably thrown out due to centrifugal force when the vehicle is in a turning state during running, the extensible solar module according to the disclosure also includes a locking member, for example, a mechanical locking member 40 may be included in the manual mode without the motor transmission structure as described above, as to lock the retraction position of the first sub board 120 and the second sub board 130 relative to the main board 110. The structure of the mechanical locking member 40 will be described in detail below with reference to FIGS. 14 to 15, wherein FIG. 14 is a schematic diagram showing the installation position of the mechanical locking member 40 according to the present disclosure; FIG. 15 is a schematic diagram showing a specific structure of a latch of a mechanical locking member according to the present disclosure. As shown in FIG. 14, the mechanical locking member 40 is arranged on the first sub board 120 and the second sub board 130 respectively, and includes a latch 410 and a baffle 420. Taking one of the locking members as an example, the baffle 420 is connected with the first sub board 120 or the second sub board 130. When the first sub board 120 and the second sub board 130 extend, the baffle 420 also extends with the first sub board 120 or the second sub board 130, When the first sub board 120 or the second sub board 130 is retracted, it is retracted together, and when the first sub board 120 or the second sub board 130 is retracted to the final state, the latch 410 clasps on the aluminum frame 111, so as to lock the full retraction state of the first sub board 120 or the second sub board 130, so as to avoid undesired throwing out due to shaking or vehicle turning.

In addition, as shown in FIG. 15, the latch 410 includes an inclined face 412 and a button part 413. As described above, when the first sub board 120 or the second sub board 130 is retracted to the final state, the inclined face 412 of the latch 410 clasps on the aluminum frame 111 to lock the fully retracted state of the first sub board 120 or the second sub board 130. When the first sub board 120 or the second sub board 130 needs to be extended again after the first sub board 120 or the second sub board 130 is completely retracted, the button part 413 can be manually pressed to retract the inclined face 412, such that the locking state of the first sub board 120 or the second sub board 130 can be unlocked, so as to extend the first sub board 120 or the second sub board 130 again.

According to another embodiment of the disclosure, the extensible solar module also includes an electromagnetic lock in the motor driving mode, so as to realize electric control and avoid the first sub board 120 and the second sub board 130 being undesirably thrown out due to centrifugal force when the vehicle is in a turning state during running.

According to another embodiment of the disclosure, the driving member 20 is a modular structure. In other words, the disclosure can provide two schemes. One is a simplified version without transmission structure. The user can manually extend or retract the first sub board and the second sub board, and the retracted state of the first sub board and the second sub board can be locked or unlocked through the above mechanical locking member 40. The other is to customize and add the driving member 20 module as described above.

The disclosure given herein illustrates each feature with its preferred embodiment and exemplary embodiment. Those skilled in the art will make many other embodiments, amendments, and modifications within the scope and spirit of the appended claims after reading the disclosure.

List of reference signs:

1: extensible solar module 2: RV
10: Solar panel member
110 main board 111 aluminum frame
1112 sub board extension groove 1113 sliding rail support
120 first sub board
130 second sub board
20: Driving member
210 DC motor 211 motor support 213 vias 215 flange bearing seat
220 connecting rod assembly
221 driving rod 223 first side rod 225 second side rod
227 first connecting bearing 229 second connecting bearing
2231 first semi-cylindrical tail 2251 second semi-cylindrical tail
30: limiting member
310 extension limiting member
320 retraction limiting member
40: locking member
410 mechanical latch 412 inclined face 413 button part
420 baffle
Second embodiment
20′ driving member
210′ double output shaft motor
220′ connecting rod assembly
221′ first screw rod 222′ second screw rod
223′ first slider 224′ second slider

What is claimed is:

1. An extensible solar module comprising:
a solar panel member which comprises a main board, a first sub board and a second sub board located on opposite sides of the main board; and
a driving member which comprises a direct current (DC) motor and a connecting rod assembly;
wherein the connecting rod assembly is connected with the first sub board and the second sub board, such that the first sub board and the second sub board are configured to be extended and retracted relative to the main board under a driving of the DC motor, when extended, the first sub board and the second sub board are located on the opposite sides of the main board, and when retracted, the first sub board and the second sub board are moved to a back of the main board and facing edges of the first sub board and the second sub board are adjacent to each other.

2. The extensible solar module according to claim 1, wherein the connecting rod assembly comprises:
a driving main rod;
a first side rod;
a second side rod, wherein the first side rod and the second side rod are respectively arranged at opposite ends of the driving main rod;
a first connecting bearing, wherein one end of the first side rod is connected with the first sub board, and a second end of the first side rod is connected with the driving main rod through the first connecting bearing; and
a second connecting bearing, wherein one end of the second side rod is connected with the second sub board, and a second end of the second side rod is connected with the driving main rod through the second connecting bearing.

3. The extensible solar module according to claim 2, wherein the one end of the first side rod connected with the first sub board forms a right angle structure, and the one end of the second side rod connected with the second sub board also forms a right angle structure.

4. The extensible solar module according to claim 3, wherein a lower end of the right angle structure of the first side rod is provided with a first semi-cylindrical tail, when the first side rod is connected with the first sub board through the first connecting bearing, the first semi-cylindrical tail is configured to be inserted into the first connecting bearing; a lower end of the right angle structure of the second side rod is provided with a second semi-cylindrical tail, when the second side rod is connected with the second sub board through the second connecting bearing, and the second semi-cylindrical tail is configured to be inserted into the second connecting bearing.

5. The extensible solar module according to claim 1, wherein the main board is an aluminum frame glass structure and comprises an aluminum frame, the first sub board and the second sub board are printed circuit boards (PCBs), and a short side of the aluminum frame of the main board is provided with two sub board extension grooves corresponding to the first sub board and the second sub board.

6. The extensible solar module according to claim 5, wherein two sliding rail supports are provided on the aluminum frame of the main board along a long side of the aluminum frame, such that a guide rail is mounted in each of the two sliding rail supports, and the first sub board and the second sub board are configured to be extended or retracted relative to the main board through the guide rails.

7. The extensible solar module according to claim 5, wherein the DC motor is provided with a motor support for installing the DC motor on the aluminum frame of the main board, the motor support is provided with a via, the DC motor is provided with a flange bearing seat, and the DC motor is connected with the motor support through the flange bearing seat.

8. The extensible solar module according to claim 1, wherein the DC motor is a double output shaft motor, and the connecting rod assembly comprises:
a first screw rod and a second screw rod, wherein one end of the first screw rod and one end of the second screw rod are respectively connected to two output shafts of the double output shaft motor, and a second end of the first screw rod and a second end of the second screw rod are respectively connected to an aluminum frame of the main board; and
a first slider and a second slider, wherein the first slider is threaded on the first screw rod and connected to the first sub board, and the second slider is threaded on the second screw rod and connected to the second sub board.

9. The extensible solar module according to claim 1, wherein the extensible solar module further comprises a limiting member which is arranged on a motor support and comprises:
an extension limiting member which is triggered when the first sub board and the second sub board are in fully extended positions to turn off operation of the DC motor; and
a retraction limiting member which is triggered when the first sub board and the second sub board are in full retraction positions to turn off the operation of the DC motor.

10. The extensible solar module according to claim 9, wherein the extension limiting member and the retraction limiting member are both metal sensors.

11. The extensible solar module according to claim 1, wherein the extensible solar module comprises a mechanical locking member in a manual mode, the mechanical locking member is respectively arranged on the first sub board and the second sub board and comprises a latch and a baffle, the latch comprises an inclined face and a button part, the inclined face is locked on an aluminum frame of the main board at a full retraction position of the first sub board and the second sub board relative to the main board, and a locking of the inclined face is configured to be released by pressing the button part.

12. The extensible solar module according to claim 1, wherein the extensible solar module further comprises an electromagnetic lock in a motor driving mode.

13. The extensible solar module according to claim 1, wherein the driving member is a modular structure.
